(19) United States
(12) Patent Application Publication
(10) Pub. No.: US 2012/0155969 A1
(43) Pub. Date: Jun. 21, 2012

(54) Anchor Module and a Method for Producing an Anchor Module

(76) Inventors: Richard Podesser, Buchloe (DE); Lothar Schwalbach, Scheuring (DE); Wolfgang Stefanelli, Nendeln (LI)

(21) Appl. No.: 13/294,732

(22) Filed: Nov. 11, 2011

(30) Foreign Application Priority Data
Nov. 11, 2010 (DE) 102010043765.4

(51) Int. Cl. E21D 21/00; F16B 13/06

(52) U.S. Cl. 405/259.5; 411/55

(57) ABSTRACT

An anchor module, in particular for mining and tunneling, is provided. The anchor module comprises an anchor rod made of plastic, extending along an anchor axis and having, after fabrication of the anchor rod, a connecting section with at least one generally smooth conical or circular cylindrical surface section in the area of at least one axial rod end. The anchor module also comprises at least one functional part extending along the anchor axis and having a tapping screw thread for cutting or tapping a screw thread in the area of the connecting section, such that after assembly of the functional part in the area of the connecting section, the anchor rod has a cut or tapped screw thread cooperating with the tapping screw thread of the functional part for transferring torques and/or tensile forces between the anchor rod and the functional part.

### RELATED APPLICATIONS

The present application claims priority to German Patent Application DE 10 2010 043 765.4, filed Nov. 11, 2010, and entitled “Ankerbaugruppe sowie Verfahren zur Herstellung einer Ankerbaugruppe” (“Anchor Module and a Method for Producing an Anchor Module”), the entire content of which is incorporated herein by reference.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The invention relates to an anchor module, in particular for mining and tunneling, as well as a method for producing same, such that the anchor module comprises an anchor rod made of plastic and at least one functional part. Anchor modules in general have already been known for a long time for rock face sealing, in particular for stabilizing mine shaft walls in mining and tunnel walls in highway construction. Anchor rods made of metal with a prefabricated thread are generally used. In addition to the anchor rod, the anchor module comprises at least one functional part, for example, a lock nut which is screwed onto the anchor rod in setting the anchor rod.

To save on cost of materials and weight, anchor modules consisting of an anchor rod made of plastic have recently come on the market, these plastic anchor rods often being designed with fiber reinforcement to improve their mechanical properties. Especially well-known examples here include so-called glass fiber reinforced plastic anchors, i.e., anchor modules having an anchor rod made of glass fiber reinforced plastic.

The anchor rods made of plastic have hardly any extensibility due to their high modulus of elasticity, and they have only a low compressive strength and shear strength. Due to the low extensibility, the anchors are placed relatively closely to prevent any movement of the substrate and to reduce the resulting shear forces per anchor. Due to the low compressive strength and shear strength, a substantial percentage of traditional glass fiber reinforced anchors are damaged or even destroyed by the compressive and shear forces occurring during installation. The known glass fiber reinforced anchor rods have a functional part, for example, a lock nut on their axial end or (in the case of self-tapping anchor modules) a drive nut with the help of which the anchor module is installed. These nuts may be made of steel or plastic and are screwed onto a thread prefabricated on the anchor rod. However, these screw connections are unable to absorb high torques or tensile forces.

The prefabricated thread, in particular on the anchor rod, can easily be damaged even before the manufacture of the anchor module, or in shipping, or in assembly of the plastic anchor, whereupon the anchor module can no longer be used. Moreover, the threaded connection between the anchor rod and the functional part can absorb only a small portion (usually only approximately 20-30%) of the maximum allowed tensile force of the anchor rod.

One advantage of glass fiber reinforced anchors is that they can absorb very high tensile forces and consequently are excellently suited for back-anchoring tunnel walls or mine shaft walls. In the case of a subsequent widening of a tunnel or mine shaft cross section, the low compressive strength and shear strength of the plastic anchor rods proves advantageous. Due to the their low shear strength, anchor rods for rock face sealing of the original tunnel or mine shaft that extend in the rock to be removed can be destroyed relatively easily by tunnel drilling machines or clearing and stripping machines while widening the cross section without damage to the machines themselves.

### SUMMARY OF THE INVENTION

The object of aspects of the present invention is to provide an anchor module which can be easily manufactured and which has a robust connection between its anchor rod made of plastic and the functional part, this connection being capable of absorbing high tensile forces and torques.

According to aspects of the present invention, this object is achieved by an anchor module, in particular for mining and tunneling, comprising an anchor rod made of plastic which extends along an anchor axis. After the anchor rod has been manufactured it has in the area of at least one axial rod end a connecting section with at least one essentially smooth, conical or circular cylindrical surface segment and at least one functional part, which can be locked directly by a threaded connection on the connecting section, and extends along the anchor axis and also has a cutting thread for cutting or tapping a thread in the area of the connecting section such that when the functional part is screwed onto the anchor rod, the anchor rod has in the area of the connecting section a cut or tapped thread cooperating with the cutting thread of the functional part for transferring torques and/or tensile forces directly between the anchor rod and the functional part. Since the anchor rod is manufactured from plastic, the cutting and/or tapping of a thread can be performed with very little effort and at a low cost. The thread on the anchor rod is produced only directly in connecting the functional part to the anchor rod and consequently cannot be damaged in advance. In addition, a connection with an extremely accurate fit, which is capable of transmitting comparatively high tensile forces and torques, is also formed due to cutting and/or tapping of the thread on the anchor rod between the anchor rod and the functional part.

The connecting section especially preferably not only has individual essentially smooth conical or circular cylindrical surface segments but also is designed to be conical or circular cylindrical over the entire surface of the connecting section. In this context, smooth surface (segments) are understood in particular to be surfaces which are originally thread-free.

The anchor rod is preferably manufactured from a fiber-reinforced plastic, in particular a glass fiber-reinforced plastic. Such a fiber-reinforcement of the plastic anchor rod has proven extremely advantageous with respect to the mechanical anchor properties.

However, the cutting thread, or especially preferably the entire functional part, may be manufactured from metal. A cutting thread suitable for cutting or tapping the anchor rod can be produced from metal, in particular from steel, with very little effort. Since the functional part also has only a fraction of the length of the anchor rod, no damage to the clearing machine or tunnel drilling machine need be feared due to this small functional part in the event that the cross section of a tunnel or mine shaft is to be expanded through rock sections that have already been anchored.

The cutting thread of the functional part is preferably designed as a sharp thread because such a thread geometry has proven to be very suitable as a cutting thread.

The cutting thread may be an inside thread and the cut thread or tapped thread may be an outside thread or vice-versa.

The anchor rod is preferably hollow at least in the area of a fastening section so that in this area optionally an inside thread and/or an outside thread may be cut or tapped.

In embodiments of the anchor module the cutting thread has a generally constant flank angle α of about 10°≦α≦40°, and in certain embodiments of about 20°≦α≦30°. This flank angle α of the cutting thread, which is very small for the thread, facilitates the cutting or tapping of the thread in the connecting section of the anchor rod.

In an alternative embodiment of the anchor module, the cutting thread has a first flank angle α₁ in the area of its threaded tip and radially connected thereto it has a second flank angle α₂ where α₂>α₁. The flank angles α₁, α₂ are selected, for example, so that the smaller flank angle provided on the threaded tip has a good thread cutting function and the larger flank angle connected thereto serves as a space holder between a lateral surface of the anchor rod and a lateral surface of the functional part.

For example, the following relationships may hold for the size of the flank angles α₁, α₂: 10°≦α₁≦30° and/or 40°≦α₂≦60°. Especially preferred values are αₗ≈20° and α₂≈50°.

The anchor rod and the functional part preferably engage with one another in a form-fitting manner in the area of the first flank angle αₗ and form a cavity in the area of the second flank angle α₂. If the connecting section has not only individual conical or circular cylindrical surface segments but instead is designed on the whole to be conical or circular cylindrical, then a helical cavity is formed in concrete terms between the anchor rod and the functional part.

In a special variant of the embodiment of the anchor module, the functional part has an opening in the area of the cavity for filling the cavity with adhesive. After the adhesive filled into the cavity has hardened, the anchor rod and the functional part are glued to one another so that the screw connection between the anchor rod and the functional part is strengthened, in particular with respect to the transfer of torques.

Preferably, the anchor module is a self-cutting anchor module and the functional part is a drive element having a drive geometry for applying a torque to the anchor module. The functional part is thus a simple component which reliably transfers drilling torques and/or is applied from the outside to the anchor rod of the self-cutting anchor module.

The drive element may in particular be a sleeve-shaped nut which is screwed onto the anchor rod as far as an axial stop and is secured on it by the cutting thread. In the case of such a nut screwed as far as the axial stop, the torques and the forces transferred can easily be adjusted via the pitch and the height of the inside thread.

Moreover, the anchor module may be a self-cutting anchor module and the functional part may be a drill bit. Thus the anchor module in one embodiment variant has the anchor rod made of plastic on whose one axial end is provided a functional part designed as a drive element and on whose opposite axial end is provided a functional part designed as a drill bit.

Certain objects described above may also achieved by a method for manufacturing the aforementioned anchor module such that the method comprises the following process steps:
a) Fabrication of an anchor rod which has in the area of at least one axial rod end a connecting section having at least one essentially smooth conical or circular cylindrical surface segment;
b) Fabrication of a functional part having a cutting thread; and
c) Screwing the functional part onto the anchor rod, such that the cutting thread of the functional part cuts and/or taps a thread into the at least one conical or circular cylindrical surface segment of the anchor rod to form a cut or tapped thread for transfer of torques and/or tensile forces between the anchor rod and the functional part.

In embodiments of a production process for the anchor module, the thread (designed at least as an outside thread) on the anchor rod is not cut or tapped until immediately when the anchor rod and the functional part are joined together. This prevents any damage to the anchor rod thread before fastening the functional part onto the anchor rod so that there is a significant reduction in rejects in the production of the anchor modules.

In a preferred variant of the method, the functional part in step c) is screwed onto the anchor rod as far as the axial stop. In addition to the threaded connection between the anchor rod and the functional part, this axial stop assumes a definitive role in the transfer of torques from the functional part to the anchor rod or vice-versa. This transfer of torques is important in particular in embodiments as a self-tapping anchor module.

In another variant of the method, a cavity between the anchor rod and the functional part is formed in step c), such that this cavity is filled with an adhesive in a process step d) following step c). This increases the adhesion between the anchor rod and the functional part which in turn has a positive effect on the transfer of torque in particular.

### BRIEF DESCRIPTION OF SEVERAL VIEWS OF THE DRAWINGS

Additional features and advantages of the invention are derived from the following description of preferred specific embodiments with reference to the drawings, in which

FIG. 1 shows a schematic longitudinal section through an anchor module formed in accordance with an embodiment of the present invention;

FIG. 2 shows a perspective view of a functional part of the inventive anchor module according to an embodiment of the present invention;

FIG. 3 shows an axial top view of the functional part of FIG. 2;

FIG. 4 shows a side view of the functional part of FIG. 2;

FIG. 5 shows a longitudinal section V-V through the functional part of FIG. 4 with two detailed views;

FIG. 6 shows a longitudinal section VI-VI through the functional part of FIG. 5 in a state in which it is screwed onto an anchor rod;

FIG. 7 shows a perspective view of a functional part of an anchor module formed in accordance with an additional embodiment of the present invention;

FIG. 8 shows a longitudinal section through the functional part of FIG. 7 with two detailed views;

FIG. 9 shows a detailed view of the anchor module according to an embodiment of the present invention in the area of a threaded tooth;

FIG. 10 shows a side view of a functional part of an anchor module formed in accordance with an additional embodiment of the present invention; and

FIG. 11 shows a schematic detailed section through the anchor module of FIG. 10 in the connecting area between the anchor rod and the functional part.

### DETAILED DESCRIPTION OF THE INVENTION

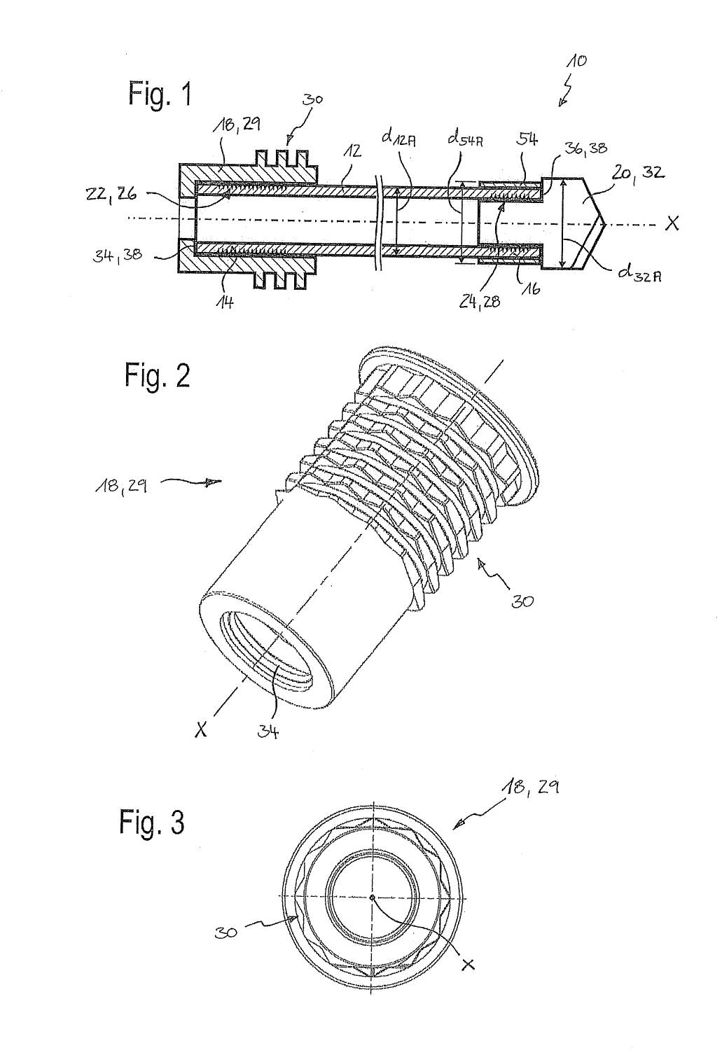

FIG. 1 shows an anchor module 10 formed in accordance with an embodiment of the present invention, particularly well adapted for mining and tunneling, comprising an anchor rod 12 made of plastic which extends along an anchor axis X and which, after fabrication of the anchor rod, has a connecting section 14, 16 in the area of each of its two axial rod ends as well as two functional parts 18, 20, each extending along the anchor axis X and each having a cutting thread 22, 24 for cutting or tapping a thread 26, 28 in the area of the connecting section 14, 16 after fabrication of the functional part.

According to FIG. 1 the anchor rod 12 has a cut thread or tapped thread 26, 28 which cooperates with the cutting thread 22, 24 of the functional parts after installation of the functional parts 18, 20 in the area of the connecting sections 14, 16 for transmitting torques and/or tensile forces between the anchor rod 12 and the functional parts 18, 20.

To be able to cut or tap threads 26, 28 in the area of the connecting sections 14, 16, the anchor rod 12 is designed to be circular cylindrical in the area of the connecting sections 14, 16. In an alternative embodiment the anchor rod 12 is designed to be conical and tapers slightly toward its axial end. In another alternative embodiment, the anchor rod 12 does not have a circular cross section in the area of its connecting sections 14, 16 but instead has opposing flattened faces, for example. It is sufficient in principle for cutting or tapping the threads 26, 28 and thus for connecting the anchor rod 12 to the functional part 18, 20 if the connecting section 14, 16 has at least one essentially smooth, conical or circular cylindrical surface segment, such that a smooth surface segment is understood to refer in particular to a surface segment, which is originally thread-free in fabrication of the anchor rod.

The anchor rod 12 made of plastic is the core piece of the anchor module 10 and, after its final installation, it anchors a tunnel wall or a mine shaft wall, for example, in a substrate or rock surrounding the tunnel or mine shaft. The anchor rod 12 is exposed to enormous tensile stresses in this back-anchoring of the tunnel wall or mine shaft wall. To be able to absorb these tensile stresses without difficulty, the anchor rod 12 according to FIG. 1 is made of fiber reinforced plastic, more specially glass fiber reinforced plastic. An anchor rod 12 made of fiber reinforced plastic offers the advantage that it can absorb high anchor tensile forces without difficulty, whereas its compressive strength and shear strength tend to be low. Because of this low compressive strength and shear strength, the anchor rod 12 and thus ultimately the entire anchor module 10 can be destroyed relatively easily in enlargement of the tunnel cross section or mine shaft cross section without damage to the construction machines used to widen the tunnel and/or mine shaft. In comparison with anchor rods 12 made of steel, the anchor rod 12 made of plastic, in particular fiber reinforced plastic, also offers advantages with regard to the cost of materials and weight.

Apart from the anchor rod 12 made of plastic, the anchor module 10 according to FIG. 1 also comprises the functional part 18, which is designed as a drive element 29 with a drive geometry 30 for applying a torque to the anchor module 10, as well as the functional part 20 designed as a drill bit 32. The anchor module 10 is thus a self-tapping anchor module 10.

In concrete terms, the drive element 29 is a sleeve-shaped nut, which is screwed onto the anchor rod 12 up to its axial stop 34 and is attached to it by the cutting thread 22. However, the connecting section of the drill bit 32 is a threaded rod, which is screwed into the anchor rod 12 until an axial stop 36 of the drill bit 32 comes in contact with an end face 38 of the anchor rod 12 and is secured to it by the cutting thread 24.

Accordingly, the cutting thread 22 may be an inside thread and the cut thread or tapped thread 26 may be an outside thread, as is shown as an example in the connection between the drive element 29 and the anchor rod 12; or the cutting thread 24 is an outside thread and the cut thread or tap thread 28 is an inside thread as is shown, for example, for the connection between the drill bit 32 and the anchor rod 12.

FIGS. 2 and 3 show a perspective detailed view and/or an axial top view of a first specific embodiment of the functional part 18 embodied as a drive element 29. The drive geometry 30 for applying a torque to the anchor module 10 can be seen well here. The drive geometry 30 of the drive element 29 is complementary to the drive geometry of a tool (not shown), for example, a screw attachment of the drilling machine, so that the tool can drive the anchor rod 12 via the drive element 29 and ultimately can drive the drill bit 32 in the circumferential direction via the anchor rod 12. Consequently, the drive geometry 30 should be embodied in such a way that it can transfer the torque applied by the tool to the anchor module 10 with as little slippage as possible. Otherwise the drive geometry 30 is freely selectable.

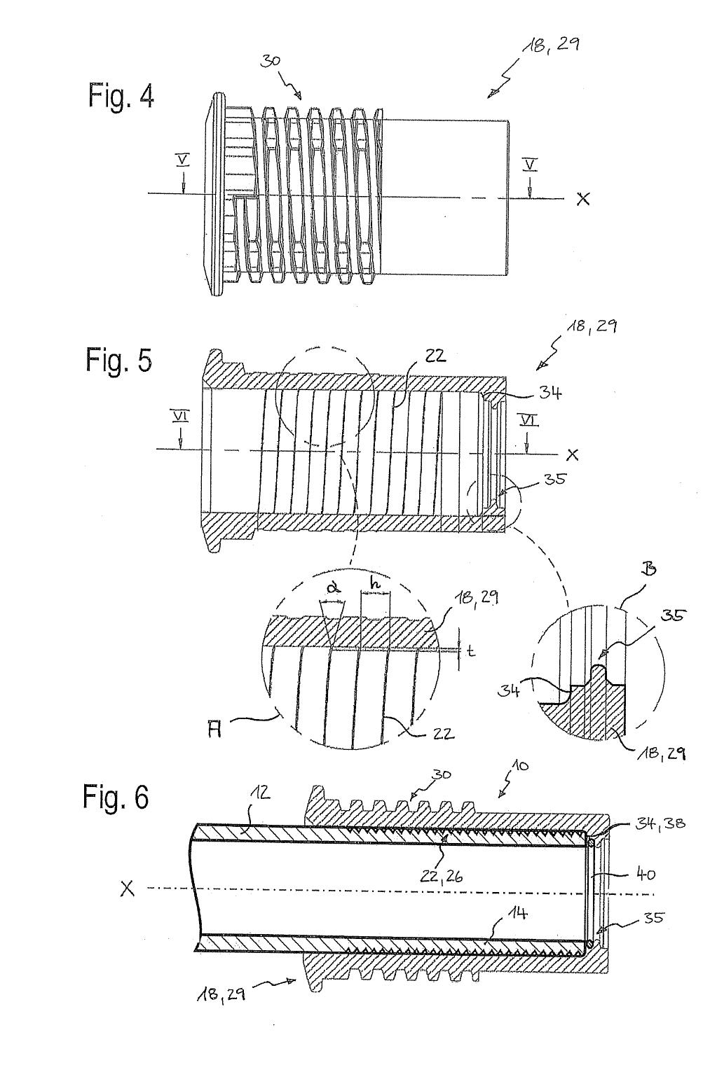

FIG. 4 shows a side view of the functional part 18 according to FIG. 2 and FIG. 5 shows a section taken along line V-V of same.

In the sectional diagram according to FIG. 5 it is clear that the functional part 18, which is embodied as a drive element 29, has the cutting thread 22, which is embodied as an inside thread. This cutting thread 22 is embodied as a sharp thread to be able to cut or tap a thread (an outside thread) in the connecting section 14 of the anchor rod 12 without having to apply a great force. FIGS. 9 and 11 (see detailed view) show examples of the thread geometry of a sharp thread.

In a detail A of a thread in FIG. 5, a thread depth t, a thread pitch h and a flank angle α are shown. The forces and torques that can be transmitted between the functional part 18 and the anchor rod 12 can be defined on the basis of the thread depth t, which is preferably on the order of about 0.5 millimeters to 1.5 millimeters, especially preferably approximately 1 millimeters, and the thread pitch h, which is preferably on the order of approximately 5 millimeters.

In the first specific embodiment of the functional part 18 according to FIGS. 2 through 6, the flank angle α of the cutting thread 22 is generally constant and is in the range of about 10°≦α≦40°, especially preferably in the range of about 20°≦α≦30°. At a flank angle α of this order of magnitude, it has been found that the thread 26 can be cut and/or tapped well in the plastic anchor rod 12, in particular when the cutting thread 22 is manufactured from a metal, preferably steel.

FIG. 5 comprises an additional detail B, which shows an axial end of the functional part 18 on an enlarged scale. This detail shows clearly the axial stop 34 as well as a sealing contour 35 of the functional part 18, which is to be connected.

FIG. 6 shows a longitudinal section taken along line VI-VI through functional part 18 according to FIG. 5, where the functional part 18 is already screwed onto an axial end, more precisely onto the connecting section 14 of the anchor rod 12. The end face 38 of the anchor rod 12 is in contact with the stop 34 of the functional part 18 here, so that the drive element 29 cannot be screwed further onto the anchor rod 12 in the direction of insertion. In addition, if a torque is applied in the direction of installation, e.g., in creating the borehole for the self-tapping anchor module 10, then the functional part 18 entrains the anchor rod 12 in the direction of rotation.

FIG. 6 also shows a sealing ring 40, which is arranged axially between the functional part 18 and the end face 38 of the anchor rod 12 in the area of the sealing contour 35, in order to seal the space between the functional part 18 and the anchor rod 12.

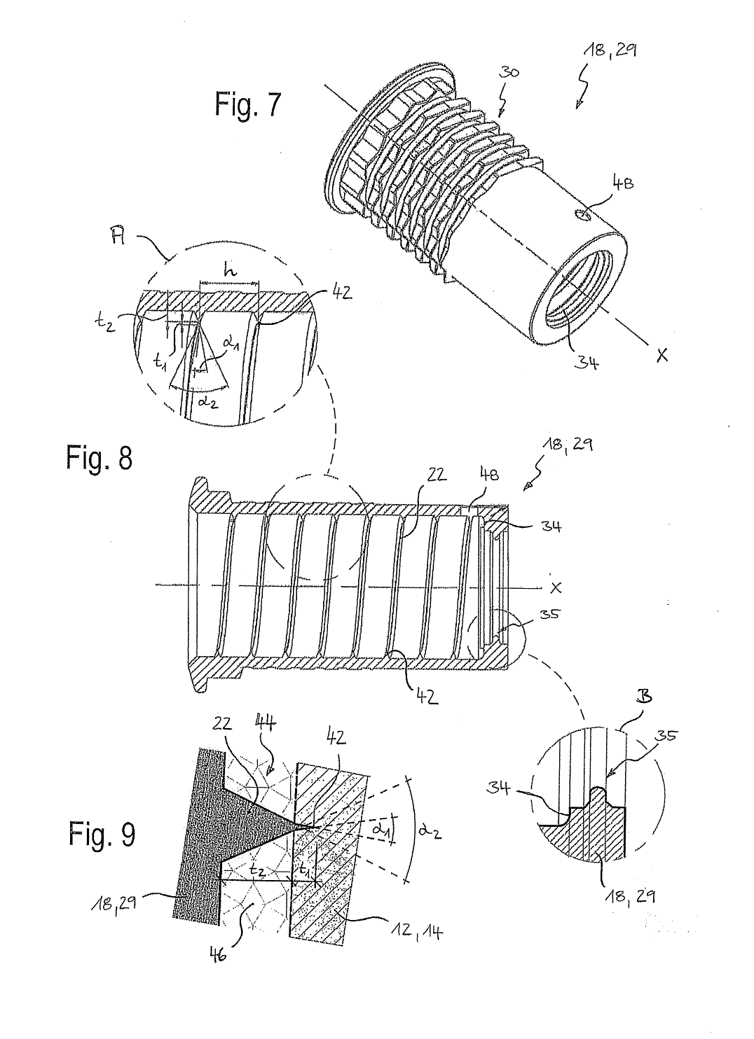

Such a seal is advantageous in particular in a second specific embodiment of the functional part 18, which is shown in FIGS. 7 through 9. Since the second specific embodiment of the functional part 18 is very similar in structure to the first specific embodiment, reference is made explicitly in this regard to the preceding discussion of FIGS. 2 through 6 so that only differences will be discussed in detail below.

FIGS. 7 and 8, like FIGS. 2 and 5, show a perspective view and a longitudinal section, respectively, through the functional part 18 according to the second specific embodiment.

On the basis of thread detail A of FIG. 8 in particular, one will notice that the cutting thread 22, in contrast with the first specific embodiment, has a first flank angle α₁ in the area of its thread tip 42 and, following that radially, a second flank angle α₂, such that α₂>α₁. The flank angles α₁, α₂ are preferably in the range of about 10°≦α₁≦30° and about 40°≦α₂≦60°. In an especially preferred specific embodiment the flank angle α₁≈20° and the flank angle α₂≈50°.

If the functional part 18 is now screwed onto the connecting section 14 of the anchor rod 12, the anchor rod 12 and the functional part 18 engage with one another in a form-fitting manner in the area of the first flank angle α₁ and form a cavity 44 in the area of the second flank angle α₂.

FIG. 9 shows a greatly enlarged detail of this connection in the area of a threaded tooth to illustrate the connection between the anchor rod 12 and the functional part 18 according to the second specific embodiment.

The pitch h of the thread is usually selected to be slightly larger than that in the first specific embodiment of the functional part 18 and is on the order of approx. 10 mm. The thread depth t of the cutting thread 22 in the second specific embodiment of the function part 18 is comprised of a section t₁ having the flank angle α₁ and a section t₂ having a flank angle α₂. Essentially only the thread portion having the flank angle α₁ cuts a thread in the connecting section 14 of the anchor rod 12. The radial section t₁ of the thread depth t is therefore comparable to the thread depth t of the first specific embodiment and is thus also on the order of about 0.5 millimeters to 1.5 millimeters, preferably approximately 0.5 millimeters. The radial section t₂ of the thread depth t of the cutting thread 22 is on the order of about 1.5 millimeters to 2.5 millimeters and serves essentially as a space holder between the anchor rod 12 and the functional part 18, which is embodied as a threaded nut, so that the anchor rod 12 and the functional part 18 are aligned concentrically after installation.

In specific embodiments in which the connecting section 14 of the anchor rod 12 has a circular cylindrical (or slightly conical) surface on the whole, the cavity 44 has a spiral or helical shape after assembly of the functional part 18 on the anchor rod 12.

In the second specific embodiment of the functional part 18, after screwing the functional part 18 onto the anchor rod 12, this cavity 44 is filled with an adhesive 46, in order to increase the adhesion between the anchor rod 12 and the functional part 18. Thus, even higher forces and torques can be transferred between the anchor rod 12 and the functional part 18 than is the case with a purely threaded connection.

To be able to introduce the adhesive 46 into the cavity 44 after assembly of the functional part 18 on the anchor rod 12, the functional part 18 has an opening 48 in the area of the cavity 44 for filling the cavity 44 with adhesive 46 (cf. FIGS. 7 and 8).

When the adhesive 46 is injected into the cavity 44, the sealing ring 40 (cf. FIG. 6) prevents the adhesive 46 from escaping out of the cavity 44 in the area of the stop 34 on the end face 38 of the anchor rod 12. The opening 48 is close to the stop 34 according to FIGS. 7 and 8 and is thus provided on an axial end of the helical cavity 44. The cavity 44 is filled from right to left, for example, according to FIG. 8, i.e., in a helical pattern in the axial direction when the liquid adhesive 46 is introduced. To facilitate filling with the adhesive 46, another opening, preferably a smaller vent opening, is provided at the end of the cavity, which is opposite the opening 48 so that the air volume displaced by the adhesive 46 can escape through this vent opening.

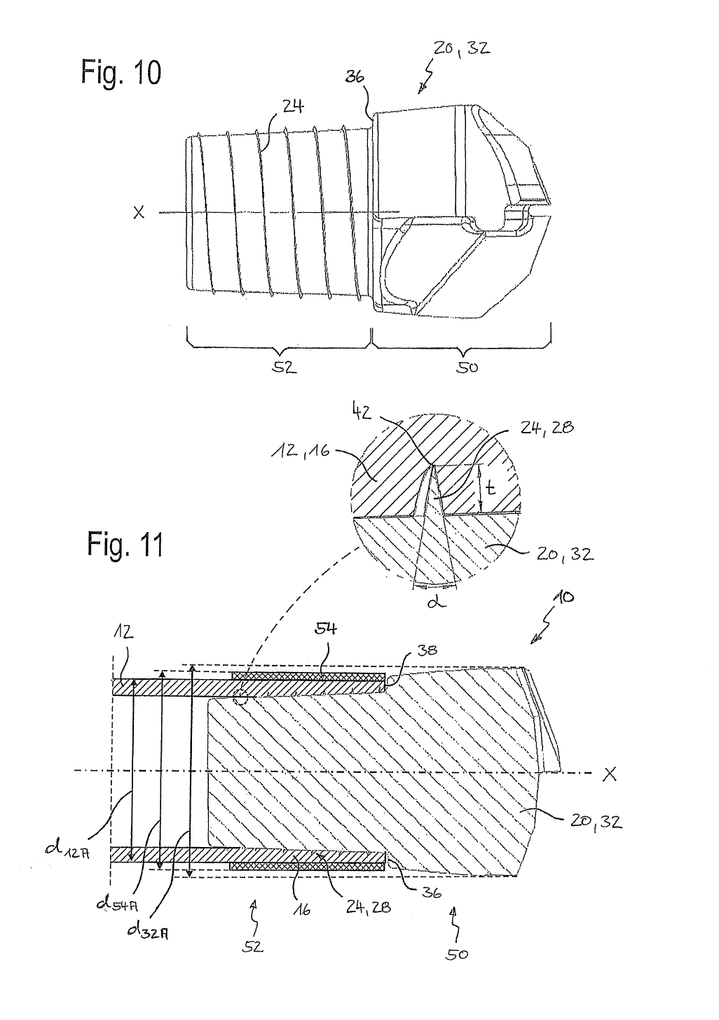

FIG. 10 shows a side view of an embodiment of the functional part 20, which is designed as a drill bit 32. The drill bit 32 comprises a drill section 50 and a connection section 52 for attaching the drill bit 32 to the anchor rod 12, more precisely to the connecting section 16 of the anchor rod 12 (cf. FIGS. 1 and 11).

After fabrication of the drill bit, the connecting section 52 of the drill bit 32 has the cutting thread 24 for cutting or tapping the thread 28 in the connecting section 16 of the anchor rod 12, such that after assembly with the drill bit 32, the anchor rod 12 has a thread 28, which is cut or tapped by the cutting thread 24 of the drill bit 32 in the area of its connecting section 16, and cooperates with it to transfer torques and/or tensile forces between the anchor rod 12 and the drill bit 32 (FIGS. 1 and 11). The connecting section 16 of the anchor rod 12 has at least one essentially smooth, i.e., in particular thread-free conical or circular cylindrical surface segment after fabrication of the anchor rod by analogy with the connecting section 14 described above. In the exemplary embodiment according to FIGS. 1 and 11, the entire connecting section 16 of the anchor rod 12 is even designed to be circular cylindrical and/or to taper conically somewhat as shown in FIG. 11.

In contrast with the functional part 18 with the inside thread, the functional part 20 has an outside thread as the cutting thread 24. The anchor rod 12 is hollow at least in the area of its connecting section 16 so that the cutting thread 24 of the drill bit 32, which is embodied as an outside thread itself cuts or taps an inside thread in the connecting section 16 of the anchor rod 12.

FIG. 11 shows a schematic sectional detail of the anchor module 10 in the area of the functional part 20, which is designed as a drill bit 32. A further enlargement in the area of the cutting thread 24 of FIG. 11 shows clearly the cutting thread 24, corresponding essentially to the cutting thread 22 of the functional part 18 in its first specific embodiment according to FIGS. 2 to 6, so that reference is made to the description of the cutting thread 22 according to the first specific embodiment of the functional part with respect to the details about the thread and the parameters of the thread.

Although not shown here, the cutting thread 24 may of course also be designed according to the cutting thread 22 of the functional part 18 in its second specific embodiment. However, since the cutting thread 24 is an outside thread, an opening must be formed for filling the corresponding cavity in the area of the cut thread or tapped thread 28 of the anchor rod 12.

If, as shown in FIG. 11, a separate sleeve 54 is also provided, surrounding the anchor rod 12 in the area of its connecting section 16, the opening for filling the cavity with adhesive would optionally also have to be provided in the sleeve 54.

FIG. 11 shows the anchor module 10, in particular for mining and tunneling, comprising the drill bit 32 with its drill section 50 and its connecting section 52 as well as the anchor rod 12 made of plastic, which extends along the anchor axis X and includes the connecting section 16 for fastening the drill bit 32 in the area of an axial rod end.

According to FIG. 11, an outside diameter d_{32A} of the drill bit 32 is at most about 20%, and in particular embodiments, at most 10%, and/or at most about 10 millimeters larger than outside diameter d_{12A} of the anchor rod 12 on the connecting section 16. The difference in outside diameter d_{32A} and d_{12A} of the drill bit 32 and the anchor rod 12 in the area of its connecting section 16 may be at most about 8 millimeters and in particular embodiments at most about 6 millimeters. Because of this small difference, when the anchor is set the result is a borehole having only a slightly larger diameter than that of the anchor rod 12. The drilling thus proceeds more rapidly, while saving more energy and causing less component stress on the anchor module 10 due to the small drill diameter. Another advantage of this small diameter difference is the lower need for filling material with which the annular space formed between the anchor rod 12 and the substrate surrounding the anchor rod 12 in drilling must be filled.

The separate sleeve 54 surrounds the anchor rod 12 in the area of its connecting section 16 according to FIG. 11, where the outside diameter d_{32A} of the drill bit 32 is larger than the outside diameter d_{54A} of the sleeve 54. The difference in the outside diameters d_{32A} and d_{54A} of drill bit 32 and sleeve 54 is preferably at most about 6 millimeters, especially preferably at most about 3 millimeters.

The sleeve 54 of the illustrated embodiment itself has a wall thickness of about a maximum of about 2 millimeters, in particular embodiments a maximum of about 1 millimeters. It is permanently attached to the anchor rod 12 with a press fit which thus secures its position axially. Due to the press fit and the design of the sleeve 54 as a closed ring, the sleeve 54 prevents radial widening or even axial breaking of the anchor rod 12 when screwing in the drill bit 32. The sleeve 54 thus contributes toward strengthening the connection between the drill bit 32 and the anchor rod 12 with respect to the forces and torques to be absorbed.

To be able to absorb the ring stresses occurring in the sleeve 54 without difficulty, the sleeve 54 may be designed as a metal sleeve, in particular as a steel sleeve.

With respect to the drill bit 32, at least the drill section 50, but preferably the entire drill bit 32 including the cutting thread 24 is made of metal, in particular steel.

According to FIG. 11, the connecting section 52 of the drill bit 32 is a threaded rod, which is screwed into the hollow anchor rod 12 until an axial stop 36 of the drill bit 32 comes in contact with the end face 38 of the anchor rod 12, and the threaded rod is attached by the cutting thread 24. The axial stop 36 on the drill bit 32 is preferably formed by the radial offset, which is present anyway between the connecting section 52 and the drill section 50. The drill bit 32 is preferably attached to the anchor rod 12 exclusively by the cutting thread 24 and the thread 28. To strengthen this connection between the drill bit 32 and the anchor rod 12, the sleeve 54 may optionally also be provided. Alternatively or additionally, the connection between the drill bit 32 and the anchor rod 12 may also be strengthened by the fact that the cutting thread 24 of the drill bit 32 is designed according to the cutting thread 22 in the second specific embodiment of the functional part 18 according to FIGS. 7 through 9, and the resulting cavity 44 is filled with adhesive 46.

Consequently, the anchor module 10 according to FIG. 1 has connections between the anchor rod 12 and the functional parts 18, 20, where these connections are able to absorb great forces and torques so that the anchor module 10 is excellent for use as a self-tapping anchor module 10. In addition, the anchor module 10 can be manufactured easily and with minimal rejects by following the method described below.

In the first process step, the anchor rod 12 has at least one connecting section 14, 16 in the area of at least one axial rod end, the connecting section having at least one surface segment, which is essentially smooth, conical or circular.

Then the functional part 18, 20 with the cutting thread 22, 24 is manufactured, such that the functional part 18, 20 may be designed, for example, as a drive element 29 or as a drill bit 32 and the cutting thread 22, 24 may be embodied as an inside thread or as an outside thread.

Finally, in another process step the functional part 18, 20 is screwed onto the anchor rod 12, such that the cutting thread 22, 24 of the functional part 18, 20 cuts or taps a thread into the at least one conical or circular cylindrical surface segment of the anchor rod 12, forming a cut thread or tapped thread 26, 28, for the transfer of torques and/or tensile forces between the anchor rod 12 and the functional part 18, 20.

The functional part 18, 20 is preferably screwed onto the anchor rod 12 in the direction of installation preferably as far as an axial stop 34, 36. If a torque is then additionally applied to the functional part 18, 20 in the installation direction, the result is a transfer of torque to the anchor rod 12 and/or a reliable entrainment of torque by the anchor rod 12 and vice-versa.

With a suitable geometry of the anchor rod 12 and the functional parts 18, 20, a helical or spiral cavity 44 is formed between the anchor rod 12 and the functional part 18, 20 when the functional part 18, 20 is screwed onto the anchor rod 12, and then this cavity is filled with the adhesive 46 in a subsequent step of the process of manufacturing the anchor module 10.

In a special variant of the embodiment, a separate sleeve 54 surrounding the anchor rod in the area of its connecting section 14, 16 may be applied to the anchor rod 12 even before screwing on the functional part 18, 20 to the anchor rod 12 in order to strengthen the threaded connection between the functional part 18, 20 and the anchor rod 12, which is formed when the former is screwed onto the latter.

In summary, the advantages of the anchor module 10 according to FIG. 1 thus include the simple process of manufacturing the anchor module 10, the minimal borehole size of the self-tapping anchor module 10, and/or the robust screw connections within the anchor module 10, which are capable of absorbing and/or transferring high forces and torques.

1. An anchor module for mining and tunneling, comprising:
an anchor rod made of plastic and extending along an anchor axis, the anchor rod having, after fabrication of the anchor rod, a connecting section with at least one generally smooth conical or circular cylindrical surface section in the area of at least one axial rod end; and
at least one functional part which can be attached by a threaded connection to the connecting section that extends along the anchor axis, the functional part including a tapping screw thread for cutting or tapping a screw thread in the area of the connecting section;
wherein the anchor rod, with the functional part screwed onto it in the area of the connecting section, has a cut or tapped screw thread cooperating with the tapping screw thread of the functional part for transferring torques and/or tensile forces between the anchor rod and the functional part.

2. An anchor module according to claim 1, wherein the anchor rod is made of a glass fiber reinforced plastic.

3. An anchor module according to claim 1, wherein the tapping screw thread is made of metal.

4. An anchor module according to claim 1, wherein the tapping screw thread is designed as a sharp thread.

5. An anchor module according to claim 1, wherein the tapping screw thread is an inside thread, and the cut or tapped thread is an outside thread, or vice versa.

6. An anchor module according to claim 1, wherein the anchor rod is hollow at least in the area of the connecting section.

7. The anchor module according to claim 1, wherein the tapping screw thread has a generally constant flank angle α of about 10°≦α≦40°.

8. An anchor module according to claim 7, wherein the tapping screw thread has a generally constant flank angle α of about 20°≦α≦30°.

9. An anchor module according to claim 1, wherein the tapping screw thread has a first flank angle α₁ in the area of a threaded tip and, connected radially thereto, a second flank angle α₂, where α₂ >α₁.

10. An anchor module according to claim 9, wherein α₁ has an angle of about 10°≦α₁≦30° and α₂ has an angle of about 40°≦α₂≦60°.

11. An anchor module according to claim 9, wherein the anchor rod and the functional part engage with one another in a form-fitting manner in the area of the first flank angle α₁ and form a cavity in the area of the second flank angle α₂.

12. An anchor module according to claim 11, wherein the functional part includes an opening in the area of the cavity for filling the cavity with an adhesive.

13. An anchor module according to claim 1, wherein the anchor module is a self-cutting anchor module and the functional part is a drive element having a drive geometry for applying a torque to the anchor module.

14. An anchor module according to claim 13, wherein the drive element is a sleeve-shaped nut, which is screwed onto the anchor rod up to an axial stop and is secured on the anchor rod by the cutting thread.

15. An anchor module according to claim 1, wherein the anchor module is a self-cutting anchor module and the functional part is a drill bit.

16. A method for producing an anchor module, the method comprising:
providing an anchor rod which has in the area of at least one axial rod end a connecting section having at least one generally smooth conical or circular cylindrical surface segment;
providing a functional part having a cutting thread; and
screwing the functional part onto the anchor rod such that the cutting thread of the functional part cuts and/or taps a thread into the at least one conical or circular cylindrical surface segment of the anchor rod to form a cut or tapped thread for transfer of torques and/or tensile forces between the anchor rod and the functional part.

17. A method according to claim 16, wherein the functional part is screwed onto the anchor rod up to an axial stop.

18. A method according to claim 16, wherein, during screwing the function part onto the anchor rod, a cavity is formed between the anchor rod and the functional part, the method including filling the cavity with an adhesive.
